(19) United States
(12) Patent Application Publication
(10) Pub. No.: US 2019/0127602 A1
(43) Pub. Date: May 2, 2019

(54) WIRE COATING MATERIAL COMPOSITION AND INSULATED WIRE

(71) Applicants: AutoNetworks Technologies, Ltd., Yokkaichi (Mie) (JP); Sumitomo Wiring Systems, Ltd., Yokkaichi (Mie) (JP); Sumitomo Electric Industries, Ltd., Osaka (JP)

(72) Inventor: Toyoki Furukawa, Yokkaichi (Mie) (JP)

(21) Appl. No.: 16/086,648

(22) PCT Filed: Apr. 6, 2017
(86) PCT No.: PCT/JP2017/014303

§ 371 Date: Sep. 20, 2018

(30) Foreign Application Priority Data
Apr. 20, 2016 (JP) 2016-084181

(51) Int. Cl. C09D 127/06; C09D 7/63; H01B 3/44

(52) U.S. Cl. CPC C09D 127/06; H01B 3/441; H01B 3/443; C09D 7/63

(57) ABSTRACT

Provided are a wire coating material composition in which buckling is suppressed and tear resistance is excellent, and an insulated wire using the same. A wire coating material composition containing polyvinyl chloride, in which the composition contains 10 to 20 parts mass of a plasticizer, more than 7 parts mass and 20 parts mass or less of a rubber component, and 0.01 to 5 parts mass of an acrylic processing aid based on 100 parts mass of polyvinyl chloride. By using the wire coating composition for wire coating material, an insulated wire 10 in which an outer periphery of a conductor 12 is coated with an insulated coating layer 14 is manufactured.

### TECHNICAL FIELD

The present disclosure relates to a composition for wire coating material and an insulated wire, and more particularly, to a composition for wire coating material suitable for a coating material of a wire that is wired in a vehicle such as an automobile, and an insulated wire using the same.

### BACKGROUND

A resin composition that contains polyvinyl chloride as a main component has been used as an insulating material for an insulated wire. For example, Patent Document 1 proposes an insulating material containing 10 to 20 parts mass of a plasticizer, 1 to 6 parts mass of chlorinated polyethylene and 1 to 6 parts mass of an MBS resin based on 100 parts mass of polyvinyl chloride, in which a sum of chlorinated polyethylene and the MBS resin is 2 to 7 parts mass.

### PRIOR ART DOCUMENT

### Patent Document

Patent Document 1: Japanese Patent No. 5729143

### SUMMARY OF THE INVENTION

### Problem to be Solved

The insulating material of Patent Document 1, even when used for a small diameter wire, suppresses a buckling when a terminal connected to a wire end is inserted into a connector, and also provides an improved flexibility and appearance of wire. However, in the insulating material of Patent Document 1, since the amount of the plasticizer is extremely small, there is a problem in that cracks occur in the wire coating due to the application of a load such as bending after external fine scratches are generated on the wire coating (decrease in tear resistance). This problem becomes particularly remarkable due to the thinning of a wire coating accompanied by the reduction in the wire diameter.

An object of the present disclosure is to provide a composition for wire coating material which has an excellent tear resistance while still having a characteristic of suppressing a buckling, and an insulated wire using the same.

### Means to Solve the Problem

In order to solve the above-mentioned problems, the composition for wire coating material according to the present disclosure contains polyvinyl chloride, in which the composition contains 10 to 20 parts of a plasticizer, more than 7 parts and 20 parts or less of a rubber component, and 0.01 to 5 parts of an acrylic processing aid based on 100 parts of the polyvinyl chloride.

The acrylic processing aid preferably has a weight-average molecular weight of 1,000,000 to 4,000,000. The rubber component is preferably one species or two or more species selected from chlorinated polyethylene and an MBS resin. The rubber component preferably contains chlorinated polyethylene, and the chlorinated polyethylene is preferably non-crystalline chlorinated polyethylene. The rubber component preferably contains an MBS resin, and the content of styrene-butadiene in the MBS resin is preferably 30 to 60 mass % based on the entire MBS resin. The plasticizer is preferably one species or two or more species selected from phthalic acid ester, trimellitic acid ester, pyromellitic acid ester, and fatty acid ester.

An insulated wire according to the present disclosure utilizes one of the compositions for wire coating material.

### Effect of the Invention

According to the composition for wire coating material of the present disclosure, it is possible to suppress a buckling and provide an improved tear resistance by containing 10 to 20 parts mass of a plasticizer, more than 7 parts mass and 20 parts mass or less of a rubber component, and 0.01 to 5 parts mass of an acrylic processing aid based on 100 parts mass of polyvinyl chloride. Further, according to the insulated wire using the composition for wire coating material as a wire coating material, it is possible to suppress a buckling and provide an improved tear resistance.

When the acrylic processing aid has a weight-average molecular weight of 1,000,000 to 4,000,000, a buckling suppression effect and tear resistance are improved. When the rubber component is one species or two or more species selected from chlorinated polyethylene and an MBS resin, the tear resistance is improved. When the rubber component contains chlorinated polyethylene and the chlorinated polyethylene is non-crystalline chlorinated polyethylene, the tear resistance is improved. When the rubber component contains an MBS resin and the content of styrene-butadiene in the MBS resin is 30 to 60 mass % based on the entire MBS resin, the tear resistance is improved. When the plasticizer is one species or two or more species selected from phthalic acid ester, trimellitic acid ester, pyromellitic acid ester, and fatty acid ester, the tear resistance is improved.

### BRIEF DESCRIPTION OF THE DRAWINGS

FIGS. 1A and 1B are a perspective view and a circumferential cross-sectional view of an insulated wire according to a first embodiment of the present disclosure, respectively.

### DETAILED DESCRIPTION TO EXECUTE THE INVENTION

Hereinafter, embodiments of the present disclosure will be described in detail.

The composition for wire coating material according to the present disclosure is a composition for wire coating material containing polyvinyl chloride, which further contains a plasticizer, a rubber component, and an acrylic processing aid in addition to polyvinyl chloride.

The polyvinyl chloride serving as a base resin is not particularly limited, but the degree of polymerization thereof may preferably be 800 or more from the viewpoint of reducing the amount of the plasticizer and suppressing the deterioration in the effect of suppressing the buckling due to the addition of the acrylic processing aid. Further, the degree of polymerization thereof may preferably be 2,800 or less from the viewpoint of suppressing the deterioration of mixing with other components. More preferably, the degree of polymerization thereof may be within a range of 1,300 to 2,500.

The plasticizer is contained within a range of 10 to 20 parts mass based on 100 parts mass of the polyvinyl chloride. When the content of the plasticizer is less than 10 parts mass, extrusion processability in manufacturing a wire deteriorates, and thus, the appearance of the insulation coating deteriorates. In addition, even though the composition contains a rubber component or an acrylic processing aid, tear resistance may not be satisfied. Meanwhile, when the content of the plasticizer exceeds 20 parts mass, a buckling may not be suppressed even though the composition contains an acrylic processing aid. Thus, a terminal insertion may not be securely performed.

Examples of the plasticizer include phthalic acid ester, trimellitic acid ester, pyromellitic acid ester, fatty acid ester, and oil. Examples of the oil include epoxidized soybean oil. These components may be used either alone or in combination of two or more thereof to be served as the plasticizer. Among them, from the viewpoint of, for example, providing an excellent plasticizing effect on polyvinyl chloride and improving the tear resistance, one species or two or more selected from phthalic acid ester, trimellitic acid ester, pyromellitic acid ester, and fatty acid ester may be preferred.

Examples of an alcohol constituting the phthalic acid ester include a saturated aliphatic alcohol having 8 to 13 carbon atoms. One or two or more of these alcohols may be used. More specifically, examples of the phthalic acid ester include di(2-ethylhexyl) phthalate, di-n-octyl phthalate, diisononyl phthalate, dinonyl phthalate, diisodecyl phthalate, and ditridecyl phthalate.

Examples of an alcohol constituting the trimellitic acid ester or the pyromellitic acid ester include saturated aliphatic alcohols having 8 to 13 carbon atoms. These alcohols may be used either alone or in combination of two or more thereof.

Examples of the fatty acid ester include adipic acid ester, sebacic acid ester, and azelaic acid ester. Examples of an alcohol constituting the fatty acid ester include saturated aliphatic alcohols having 3 to 13 carbon atoms. These alcohols may be used either alone or in combination of two or more thereof. More specifically, examples of the fatty acid ester include dioctyl adipate, isononyl adipate, dibutyl sebacate, dioctyl sebacate, and dioctyl azelate.

The rubber component is contained within a range of more than 7 parts mass and 20 parts mass or less based on 100 parts mass of the polyvinyl chloride. Since the amount of the plasticizer is reduced, when the content of the rubber component is 7 parts mass or less, the tear resistance is lowered. Furthermore, when the content of the rubber component exceeds 20 parts mass, a buckling may not be suppressed even though the composition contains an acrylic processing aid. Thus, a terminal insertion may not be securely performed. From the above viewpoint, the content of the rubber component may more preferably be 7.5 parts mass or more, and still more preferably 8 parts mass or more. Further, the content of the rubber component may yet more preferably be 18 parts mass or less, and may still yet more preferably be 15 parts mass or less.

Examples of the rubber component include chlorinated polyethylene, an MBS resin, a thermoplastic polyester elastomer, and a thermoplastic polyurethane elastomer. These components may be used either alone or in combination of two or more thereof to be served as the rubber component. Among the rubber components, one species or two or more species selected from the chlorinated polyethylene and the MBS resin may preferably be used from the viewpoint of providing a particularly excellent effect of improving the tear resistance.

As for the chlorinated polyethylene, those containing chlorine within a range of 15 to 45 mass % may be suitably used. Examples of the chlorinated polyethylene include non-crystalline chlorinated polyethylene and semi-crystalline chlorinated polyethylene. These components may be used either alone or in combination of two or more species thereof. Among the chlorinated polyethylene, the non-crystalline chlorinated polyethylene is particularly preferred from the viewpoint of providing a particularly excellent effect of improving the tear resistance.

The MBS resin is a polymer obtained by a graft polymerization of an acrylic monomer such as, for example, methyl acrylate and ethyl acrylate or a styrene monomer to components such as, for example, polybutadiene or a styrene-butadiene based copolymer. The obtained MBS resin polymer may suitably have a styrene-butadiene content of 20 to 75 mass %. Among the polymer having a styrene-butadiene content of 20 to 75 mass %, the styrene-butadiene content may more preferably be within a range of 30 to 60 mass %, and may still more preferably be within a range of 35 to 50 mass % from the viewpoint of providing an excellent effect of improving the tear resistance.

The thermoplastic polyester elastomer includes a block copolymer composed of a hard segment and a soft segment. Examples of the hard segment include an aromatic polyester chain such as PBT or PBN, and an aliphatic polyester chain. Examples of the soft segment include an aliphatic polyether chain and an aliphatic polyester chain.

Examples of the thermoplastic polyurethane elastomer include a polyether thermoplastic polyurethane elastomer having a soft segment formed with a polyether chain, and a polyester thermoplastic polyurethane elastomer having a soft segment formed with a polyester chain. The thermoplastic polyurethane elastomer is not particularly limited, but the soft segment may preferably be formed with a polyether chain from the viewpoint of providing an excellent effect of improving the tear resistance. In addition, the Shore hardness may preferably be A75 or more from the viewpoint of providing an excellent effect of suppressing the buckling. The Shore hardness may more preferably be A85 or less from the viewpoint of providing an excellent effect of improving the tear resistance.

The acrylic processing aid is contained within a range of 0.01 to 5 parts mass based on 100 parts mass of the polyvinyl chloride. Although the amount of the plasticizer is reduced, the rubber component is contained in a large amount for the tear resistance. Thus, when the content of the acrylic processing aid is less than 0.01 parts mass, a buckling may not be suppressed, and thus, a terminal insertion may not be securely performed. Furthermore, it is insufficient to have an effect of improving the tear resistance only by increasing the amount of the rubber component. The effect of improving the tear resistance may be obtained by containing the acrylic processing aid together with the rubber component. Meanwhile, when the content of the acrylic processing aid exceeds 5 parts mass, extrusion processability at the time of manufacturing the wire deteriorates, so that the appearance of the insulation coating deteriorates. Further, the effect of suppressing a buckling deteriorates, and a buckling may not be suppressed. Thus, a terminal insertion may not be securely performed. From the above viewpoints, the content of the acrylic processing aid may more preferably be 0.1 parts mass or more, and may still more preferably be 0.5 parts mass or more. In addition, the content of the rubber component may more preferably be 4 parts mass or less, and may still more preferably be 3 parts mass or less.

The acrylic processing aid may preferably have a weight-average molecular weight of 1,000,000 to 4,000,000. The acrylic processing aid has a weight-average molecular weight of more preferably 1,000,000 to 3,000,000, and still more preferably 1,000,000 to 2,000,000. When the acrylic processing aid has a weight-average molecular weight of 1,000,000 to 4,000,000, an effect of suppressing the buckling and tear resistance may be improved.

The acrylic processing aid is a polymer or a copolymer containing acrylic acid, acrylic acid ester, methacrylic acid, or methacrylic acid ester as a monomer. The acrylic processing aid may preferably be a copolymer. More specific examples of the monomer include methyl acrylate, ethyl acrylate, n-butyl acrylate, isobutyl acrylate, 2-ethylhexyl acrylate, cyclohexyl acrylate, methyl methacrylate, ethyl methacrylate, n-butyl methacrylate, isobutyl methacrylate, 2-ethylhexyl methacrylate, and cyclohexyl methacrylate. These components may be used either alone or in combination of two or more thereof as a monomer of the acrylic processing aid.

The composition for wire coating material according to the present disclosure may contain other components than the polyvinyl chloride, the plasticizer, the rubber component, and the acrylic processing aid within a range that does not impair the object of the present disclosure. Examples of the other components include additives which are typically used for a wire coating material, such as a stabilizer, a pigment, an antioxidant, and a bulking agent.

The composition for wire coating material according to the present disclosure may be prepared, for example, by blending polyvinyl chloride serving as a base resin with a plasticizer, a rubber component, an acrylic processing aid, and various additives which may be added as necessary, and heating and kneading the resulting mixture. In this case, it is possible to use a typical kneader such as a Banbury mixer, a pressure kneader, a kneading extruder, a twin-screw extruder, or a roll. The mixture may also be dry-blended in advance with, for example, a tumbler before the heating and kneading. After the heating and kneading, the resulting product is taken out from the kneader to obtain a composition. At that time, the composition may be molded into a pellet shape with, for example, a pelletizer.

Next, the insulated wire according to the present disclosure will be described.

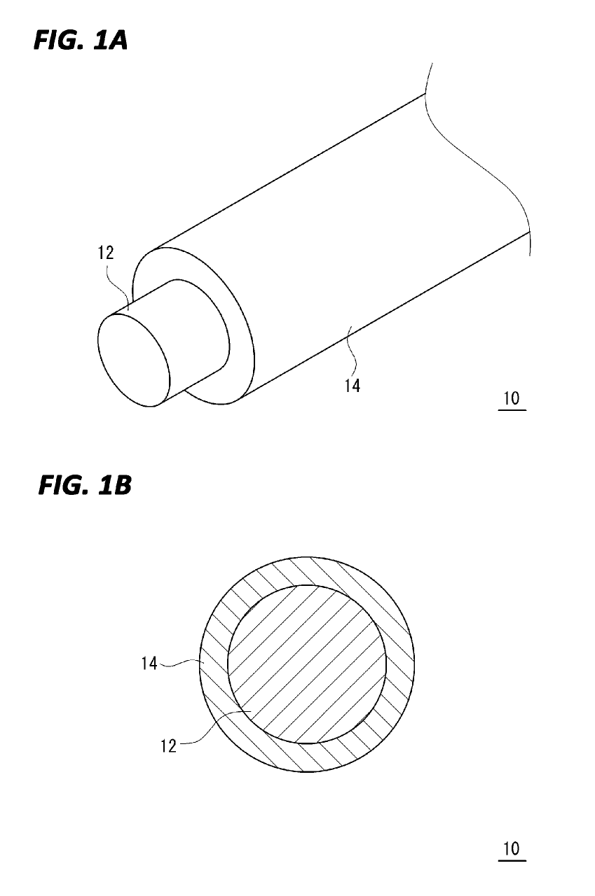

FIGS. 1A and 1B illustrate a perspective view and a cross-sectional view (a circumferential cross-sectional view) with respect to an insulated wire according to a first embodiment of the present disclosure, respectively. As illustrated in FIGS. 1A and 1B, an insulated wire 10 includes a conductor 12 and an insulated coating layer (wire coating material) 14 coating the outer periphery of the conductor 12. The insulated coating layer 14 is formed by using the composition for wire coating material according to the present disclosure. The insulated wire 10 is obtained by an extrusion-coating of the composition for wire coating material according to the present disclosure onto the outer periphery of the conductor 12.

Copper is generally used for the conductor 12, but any material such as aluminum and magnesium may also be used in addition to copper. The material may be a metallic alloy. Examples of other metal materials for forming a metallic alloy include iron, nickel, magnesium, silicon, and combinations thereof. The conductor 12 may be composed of a single wire or a twisted wire formed by twisting a plurality of strands.

According to the composition for wire coating material and the insulated wire having the above configuration, it is possible to suppress a buckling and have excellent tear resistance by containing 10 to 20 parts mass of the plasticizer, more than 7 parts mass and 20 parts mass or less of the rubber component, and 0.01 to 5 parts mass of the acrylic processing aid based on 100 parts mass of the polyvinyl chloride. Furthermore, according to the insulated wire using the composition for wire coating material, it is possible to suppress a buckling and have excellent tear resistance.

The insulated wire according to the present disclosure is suitable for a small diameter wire because of a suppressed buckling and an improved tear resistance. Examples of the small diameter wire include a wire of which the outer diameter is formed to have a diameter φ less than 1.1 mm In this case, the thickness of the insulated coating layer has a standard thickness of 0.25 mm or less. When the thickness of the insulated coating layer exceeds 0.25 mm, a thinning of the insulated coating layer may be insufficient. Further, when the thickness of the insulated coating layer exceeds 0.25 mm, the conductor becomes relatively too thin because the outer diameter of the wire is less than 1.1 mm As a result, the conductivity becomes insufficient. In addition, the thickness of the insulated coating layer may preferably be 0.1 mm or more. When the thickness of the insulated coating layer is less than 0.1 mm, it is difficult to uniformly form a coating of the insulated coating layer. Thus, an insulation performance may not be sufficiently exhibited.

The insulated wire according to the present disclosure may be, for example, a wire in which the conductor is coated with an insulated coating layer, the wire outer diameter is set to a diameter φ less than 1.1 mm, the insulated coating layer has a thickness of 0.25 mm or less, and the composition for wire coating material according to the present disclosure is used for a material for the insulated coating layer.

Moreover, the insulated wire according to the present disclosure may be used for various wires for, for example, automobile, equipment, information communication, electric power, ships, and aircrafts. In particular, the insulated wire according to the present disclosure may be suitably used as a wire for automobile.

Although the embodiments of the present disclosure have been described in detail, the present disclosure is not limited to the above embodiments at all, and various modifications thereof may be possible without departing from the gist of the present disclosure.

For example, the insulated wire may be formed in a form of, for example, a flat wire or a shielded wire, in addition to the single wire as illustrated in FIGS. 1A and 1B. Further, the insulated layer may be composed of two or more layers.

### EXAMPLES

Hereinafter, the present disclosure will be described in detail with reference to Examples, but the present disclosure is not limited by the Examples.

### Examples 1 to 20

(Preparation of Wire Coating Material Composition)

Polyvinyl chloride, a plasticizer, a rubber component, an acrylic processing aid, and a lead-free heat stabilizer were mixed in a blending composition (parts mass) shown in Tables 1 and 2 at 180° C. by using a twin-screw extruder, and the resulting mixture was molded into a pellet shape by a pelletizer to prepare the composition for wire coating material containing polyvinyl chloride.

(Fabrication of Insulated Wire)

An insulated wire (wire outer diameter 0.85 mm) was fabricated by an extrusion-molding of the prepared composition for wire coating material around a stranded wire conductor having a cross-sectional area of 0.13 mm² in a coating thickness of 0.2 mm

### Comparative Examples 1 to 8

Preparation of the composition for wire coating material and fabrication of insulated wires were carried out in the same manner as in the Examples, except that the respective components were mixed in the blending composition (parts mass) shown in Table 3.

(Materials Used)

Polyvinyl chloride

(Degree of polymerization: 1,300): “ZEST1300Z” manufactured by Shin Dai-Ichi Vinyl Corporation

(Degree of polymerization: 2,500): “ZEST2500Z” manufactured by Shin Dai-Ichi Vinyl Corporation

Plasticizer

Phthalic acid ester: “DUP” manufactured by J-PLUS Co., Ltd.

Trimellitic acid ester: “Monocizer W-750” manufactured by DIC Corporation

Pyromellitic acid ester: “Monocizer W-7010” manufactured by DIC Corporation

Fatty acid ester: “Monocizer W-242” manufactured by DIC Corporation

Epoxidized soybean oil: “Epocizer W-100-EL” manufactured by DIC Corporation

Rubber component

Non-crystalline chlorinated polyethylene: “Elaslen 401A” manufactured by Showa Denko K. K.

Semi-crystalline chlorinated polyethylene: “Elaslen 404B” manufactured by Showa Denko K. K.

MBS (Rubber component 50%): “KaneAce B-564” manufactured by Kaneka Corporation

MBS (Rubber component 25%): “KaneAce B-513” manufactured by Kaneka Corporation

Polyester elastomer: “hytrel 4777” manufactured by Du Pont-Toray Co., Ltd.

Polyurethane elastomer: “Elastollan ET385” manufactured by BASF Japan Ltd.

Acrylic processing aid

Molecular weight Mw 1,500,000: “Metablen P-551A” manufactured by Mitsubishi Rayon Co., Ltd.

Molecular weight Mw 700,000: “Metablen P-501A” manufactured by Mitsubishi Rayon Co., Ltd.

Molecular weight Mw 4,500,000: “Metablen P-531A” manufactured by Mitsubishi Rayon Co., Ltd.

Molecular weight Mw 3,000,000: “Metablen P-530A” manufactured by Mitsubishi Rayon Co., Ltd.

Lead-free stabilizer: trade name “RUP-110” manufactured by ADEKA Corporation

(Evaluation)

For the fabricated insulated wire, a buckling and a tear resistance were evaluated based on the following evaluation method.

<Buckling Force>

The insulated wire was held at a position of 10 mm from the end of the insulated wire, the insulated wire was pressed against a flat plate at a constant speed (200 mm/min), a load when the insulated wire was bent was measured, and the load was regarded as a buckling force (N). The buckling force test evaluates the degree of buckling of an insulated wire when the insulated wire is inserted into a terminal of a connector. A higher numerical value of buckling force indicates that buckling is more difficult. When the buckling force (N) is 11 (N) or more, it is determined that a good work may be performed when actually inserting the insulated wire into the connector terminal, and it is evaluated as “A” (pass). When the buckling force (N) is 10 (N) or more, it is determined that work may sufficiently be carried out, and it is evaluated as “B” (pass). When the buckling force (N) is less than 10 (N), it is evaluated as “C” (fail).

<Evaluation of Tear Resistance>

An angle type test piece described in JIS K 6252 was fabricated from a 1-mm thick sheet fabricated from the prepared composition for wire coating material, and the tear resistance was evaluated by using a tensile tester. The distance between the gripping tools was set to 20 mm and the tensile speed was set at 50 mm/min. When the test piece was ruptured with a stroke of 10 mm (apparent strain 50%) or more, the tear resistance was evaluated as pass “B,” and when the test piece was ruptured with a stroke of 20 mm (apparent strain 100%) or more, the tear resistance was evaluated as excellent “A.” Meanwhile, when the test piece was ruptured with a stroke of less than 10 mm, the tear resistance was evaluated as fail “C.”

TABLE 1

| | | Example | | | | | | | | |
|---|---|---|---|---|---|---|---|---|---|---|
| | | 1 | 2 | 3 | 4 | 5 | 6 | 7 | 8 | 9 |
| Polyvinyl chloride | Degree of polymerization = 1300 | 100 | 100 | 100 | 100 | 100 | 100 | 100 | 100 | 100 |
| | Degree of polymerization = 2500 | | | | | | | | | |
| Plasticizer | Phthalic acid ester | | | | 15 | | | | | |
| | Trimellitic acid ester | 15 | 10 | 20 | | | | | 15 | 15 |
| | Pyromellitic acid ester | | | | | 15 | | | | |
| | Fatty acid ester | | | | | | 15 | | | |
| | Epoxidized soybean oil | | | | | | | 15 | | |
| Rubber component | Non-crystalline chlorinated polyethylene | 10 | 10 | 10 | 10 | 10 | 10 | 10 | 7.5 | 20 |
| | Semi-crystalline chlorinated polyethylene | | | | | | | | | |
| | MBS (50%) | | | | | | | | | |
| | MBS (25%) | | | | | | | | | |
| | Polyester elastomer | | | | | | | | | |
| | Polyurethane elastomer | | | | | | | | | |
| Acrylic processing aid | Molecular weight Mw: 1,500,000 | 2 | 2 | 2 | 2 | 2 | 2 | 2 | 2 | 2 |
| | Molecular weight Mw: 700,000 | | | | | | | | | |
| | Molecular weight Mw: 4,500,000 | | | | | | | | | |
| Lead-free heat stabilizer | | 5 | 5 | 5 | 5 | 5 | 5 | 5 | 5 | 5 |
| Evaluation result | Buckling force | A | A | A | A | A | A | A | A | A |
| | Tear resistance | A | A | A | A | A | A | B | A | A |

TABLE 2

| | | Example | | | | | | | | | | |
|---|---|---|---|---|---|---|---|---|---|---|---|---|
| | | 10 | 11 | 12 | 13 | 14 | 15 | 16 | 17 | 18 | 19 | 20 |
| Polyvinyl chloride | Degree of polymerization = 1300 | 100 | 100 | 100 | 100 | 100 | 100 | 100 | 100 | 100 | | 100 |
| | Degree of polymerization = 2500 | | | | | | | | | | 100 | |
| Plasticizer | Phthalic acid ester | | | | | | | | | | | |
| | Trimellitic acid ester | 15 | 15 | 15 | 15 | 15 | 15 | 15 | 15 | 15 | 15 | 15 |
| | Pyromellitic acid ester | | | | | | | | | | | |
| | Fatty acid ester | | | | | | | | | | | |
| | Epoxidized soybean oil | | | | | | | | | | | |
| Rubber component | Non-crystalline chlorinated polyethylene | | | | | | 10 | 10 | 10 | 10 | 10 | 10 |
| | Semi-crystalline chlorinated polyethylene | 10 | | | | | | | | | | |
| | MBS (50%) | | 10 | | | | | | | | | |
| | MBS (25%) | | | 10 | | | | | | | | |
| | Polyester elastomer | | | | 10 | | | | | | | |
| | Polyurethane elastomer | | | | | 10 | | | | | | |
| Acrylic processing aid | Molecular weight Mw: 1,500,000 | 2 | 2 | 2 | 2 | 2 | 0.01 | 5 | | | 2 | |
| | Molecular weight Mw: 700,000 | | | | | | | | 2 | | | |
| | Molecular weight Mw: 4,500,000 | | | | | | | | | 2 | | |
| | Molecular weight Mw: 3,000,000 | | | | | | | | | | | 2 |
| Lead-free heat stabilizer | | 5 | 5 | 5 | 5 | 5 | 5 | 5 | 5 | 5 | 5 | 5 |
| Evaluation result | Buckling force | A | A | A | A | A | A | A | B | B | A | A |
| | Tear resistance | B | A | B | B | B | A | A | A | A | A | A |

TABLE 3

| | | Comparative Example | | | | | | | |
|---|---|---|---|---|---|---|---|---|---|
| | | 1 | 2 | 3 | 4 | 5 | 6 | 7 | 8 |
| Polyvinyl chloride | Degree of polymerization = 1300 | 100 | 100 | 100 | 100 | 100 | 100 | 100 | 100 |
| | Degree of polymerization = 2500 | | | | | | | | |
| Plasticizer | Phthalic acid ester | | | | | | | | |
| | Trimellitic acid ester | 7.5 | 22.5 | 15 | 15 | 15 | 15 | 15 | 15 |
| | Pyromellitic acid ester | | | | | | | | |
| | Fatty acid ester | | | | | | | | |
| | Epoxidized soybean oil | | | | | | | | |
| Rubber component | Non-crystalline chlorinated polyethylene | 10 | 10 | | 7 | 22.5 | 10 | 10 | 10 |
| | Semi-crystalline chlorinated polyethylene | | | | | | | | |
| | MBS (50%) | | | | | | | | |
| | MBS (25%) | | | | | | | | |
| | Polyester elastomer | | | | | | | | |
| | Polyurethane elastomer | | | | | | | | |
| Acrylic processing aid | Molecular weight Mw: 1,500,000 | 2 | 2 | 2 | 2 | 2 | | 0.001 | 7.5 |
| | Molecular weight Mw: 700,000 | | | | | | | | |
| | Molecular weight Mw: 4,500,000 | | | | | | | | |
| Lead-free heat stabilizer | | 5 | 5 | 5 | 5 | 5 | 5 | 5 | 5 |
| Evaluation result | Buckling force | A | C | A | A | C | C | C | C |
| | Tear resistance | C | A | C | C | A | C | C | A |

In Comparative Example 1, since the plasticizer was contained in a small amount, the tear resistance is not satisfied. In Comparative Example 2, since the plasticizer was contained in a large amount, the buckling force is small, so that the buckling suppression is not satisfied. In Comparative Example 3, since the composition does not contain a rubber component when the amount of the plasticizer is reduced, the tear resistance is not satisfied. In Comparative Example 4, since the rubber component is contained in a small amount, the tear resistance is not satisfied. In Comparative Example 5, since the rubber component is contained in a large amount even when the amount of the plasticizer is reduced, the buckling force is small, so that the buckling suppression is not satisfied. In Comparative Example 6, the amount of the plasticizer is reduced, and the rubber component is contained in an appropriate amount, but the acrylic processing aid is not contained. Thus, the buckling force is small, so that the buckling suppression is not satisfied. Further, even though the amount of the plasticizer is reduced and the rubber component is contained in an appropriate amount, the tear resistance is not satisfied. In Comparative Example 7, the amount of the plasticizer is reduced, and the rubber component is contained in an appropriate amount, but the acrylic processing aid is contained in a small amount. Thus, the buckling force is small, so that the buckling suppression is not satisfied. In addition, the tear resistance is not satisfied as well. In Comparative Example 8, the amount of the plasticizer is reduced, and the rubber component is contained in an appropriate amount, but the acrylic processing aid is contained in a large amount. Thus, the buckling force is small, so that the suppressing buckling is not satisfied.

In contrast, according to the Examples satisfying the configuration of the present disclosure, the buckling force is large, so that the buckling suppression and the tear resistance are satisfied. Moreover, from the comparison of the Examples with Comparative Example 6, it can be seen that the tear resistance is not satisfied merely by reducing the amount of the plasticizer and containing the rubber component in an appropriate amount, and the combination of the rubber component and the acrylic processing aid is effective for improving the tear resistance. Furthermore, as shown in the comparison between the Examples, when the weight-average molecular weight of the acrylic processing aid is 1,000,000 to 4,000,000, the effect of the buckling suppression is improved (Examples 1, 17, 18, and 20). When the rubber component is one or two or more selected from chlorinated polyethylene and an MBS resin, the tear resistance is improved (Examples 1, 11, 13, and 14). When the rubber component includes chlorinated polyethylene and the chlorinated polyethylene is non-crystalline chlorinated polyethylene, the tear resistance is improved (Examples 1 and 10). When the rubber component includes an MBS resin and the content of styrene-butadiene in the MBS resin is 30 to 60 mass % based on the entire MBS resin, the tear resistance is improved (Examples 11 and 12). When the plasticizer is one or two or more selected from phthalic acid ester, trimellitic acid ester, pyromellitic acid ester, and fatty acid ester, the tear resistance is improved (Examples 1 and 4 to 7).

### DESCRIPTION OF SYMBOLS

10: Insulated wire, 12: Conductor, 14: Insulated coating layer

1. A composition for wire coating material containing polyvinyl chloride, wherein the composition contains 10 to 20 parts mass of a plasticizer, more than 7 parts mass and 20 parts mass or less of a rubber component, and 0.01 to 5 parts mass of an acrylic processing aid based on 100 parts mass of the polyvinyl chloride,
the rubber component contains an MBS resin, and
a content of styrene-butadiene in the MBS resin is 30 to 60 mass % based on the entire MBS resin.

2. The composition for wire coating material according to claim 1, wherein the acrylic processing aid has a weight-average molecular weight of 1,000,000 to 4,000,000.

3. The composition for wire coating material according to claim 1, wherein the rubber component contains chlorinated polyethylene.

4. The composition for wire coating material according to claim 3, wherein the rubber component contains chlorinated polyethylene, and the chlorinated polyethylene is non-crystalline chlorinated polyethylene.

5. The composition for wire coating material according to claim 1, wherein the plasticizer is one species or two or more species selected from phthalic acid ester, trimellitic acid ester, pyromellitic acid ester, and fatty acid ester.

6. An insulated wire, wherein the composition for wire coating material according to claim 1 is used for a wire coating material.

7. (canceled)
